(19) United States
(12) Patent Application Publication
(10) Pub. No.: US 2006/0160580 A1
(43) Pub. Date: Jul. 20, 2006

(54) Extended microphone with lighting device

(76) Inventor: Kuo-Chung Chen, Taipei Hsien (TW)

Correspondence Address: Jdi Jing Deng Industrial Co., Ltd., P. O. Box No. 6-57, Junghe, Taipei, 235, TW

(21) Appl. No.: 11/034,765

(22) Filed: Jan. 14, 2005

(51) Int. Cl. H04M 1/00

(52) U.S. Cl. 455/569.1

(57) ABSTRACT

An extended microphone with a lighting device applied in a radio communication equipment is disclosed. The extended microphone for a radio communication equipment includes a microphone body; an adapter for connecting said extended microphone with said radio communication equipment; an extended line connected between said microphone body and said adapter; and a lighting module disposed on said microphone body for providing a light source while said extended microphone is connected with said radio communication equipment via said adapter.

### BACKGROUND OF THE INVENTION

(a) Field of the Invention

This invention relates to an extended microphone, and more particularly to an extended microphone with a lighting device applied in a radio communication equipment.

(b) Description of the Prior Art

Generally speaking radio communication equipments are used for transmitting and receiving voice messages. According to the prior art, radio communication equipments could include at least a transmitter, a receiver, a microphone and a loud speaker. As shown in FIG. 1, the traditional radio communication equipment 1 includes a microphone 11, a loud speaker 12, an aerial 13 and a power set 14, wherein a transmitter and a receiver (not shown in FIG. 1) are also included therein for transmitting and receiving voice messages. This kind of radio communication equipments always is provided powder via batteries; but some radio communication equipments disposed in a car are provided powder via the powder of the car. When a user speaks to a microphone, his voice messages are transferred into electronic messages. These electronic messages are produced by the transmitter and amplified into radio messages for transmitting to the aerial, and then the radio messages are transmitting into air via the aerial. On the other hand, the aerial of accepting side will receive the radio messages and transmit them to the receiver thereof. The receiver further transfers the radio messages into the original voice message, and then the voice messages are broadcasted via the loud speaker of the radio communication equipment, thereby accepting-side user being able to hear the original voice message from remote user.

In practice, the volume and the weight of the radio communication equipment are too large to be held or carry. Therefore, the radio communication is always performed with an extended microphone 2, as shown in FIG. 2, for facilitating to be performed. Meanwhile the extended microphone 2 further includes a control button 21, an extended line 22, an adapter 23, a microphone 23 and a loud speaker 25. The extended microphone works by means of inserting the adapter 23 of the extended microphone into an interface hole 15 of the radio communication equipment.

However, the extended microphone of prior art is introduced for facilitating to perform, but without adding another new functions. On the other hand, there is no lighting device disposed on the radio communication equipment according to the prior art. It isn't convenient to operate the radio communication equipment in the dark. Furthermore, the user can't look about via the radio communication equipment.

Because the prior radio communication equipment is limited in radio communication system, it can't provide an additional lighting service.

Therefore, it needs to provide an extended microphone, which is capable of being attached to a radio communication system and providing the lighting service, and can rectify those drawbacks of the prior art and solve the above problems. Meanwhile a traditional radio communication equipment could provide the lighting service by means of introducing the extended microphone according to the present invention without disassembling the radio communication equipment for adding extra functions.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

It is an object of the present invention to provide an extended microphone for a radio communication equipment, wherein a lighting module is introduced into the extended microphone for providing a light source without refitting the radio communication equipment.

According to the present invention, the extended microphone for a radio communication equipment, includes a microphone body; an adapter for connecting the extended microphone with the radio communication equipment; an extended line connected between the microphone body and the adapter; and a lighting module disposed on the microphone body for providing a light source while the extended microphone is connected with the radio communication equipment via the adapter.

Preferably, the extended microphone further includes a voice-receiving button connected to the microphone body for enabling the microphone body to receive a voice message, wherein the voice message is further transmitted into the radio communication equipment.

Preferably, the extended microphone further includes a light button disposed on the microphone body and connected with the lighting module for controlling the lighting module to radiate.

Preferably, the extended microphone further includes a power source set connected with the lighting module for providing the lighting module with an individual power.

Certainly, the lighting module can be one selected from a group of a high-power luminary, an incandescent lamp, and a LED luminary.

According to the present invention, the extended microphone for a radio communication equipment, at least includes a microphone body; an adapter connected with the microphone body for linking the extended microphone and the radio communication equipment; and a lighting module disposed on the microphone body for providing a light source while the extended microphone and the radio communication equipment are linked via the adapter.

Preferably, the extended microphone further includes a voice-receiving button connected to the microphone body for enabling the microphone body to receive a voice message, wherein the voice message is further transmitted into the radio communication equipment.

Preferably, the extended microphone further includes a light button disposed on the microphone body and connected with the lighting module for controlling the lighting module to radiate.

Preferably, the extended microphone further includes a power source set connected with the lighting module for providing the lighting module with an individual power.

Certainly, the lighting module can be a high-power luminary.

Certainly, the lighting module can be an incandescent lamp.

Certainly, the lighting module can be a LED luminary.

Preferably, the extended microphone further includes an extended line connected between the microphone body and the adapter.

According to the present invention, the extended microphone for a radio communication equipment, includes a microphone body; an adapter for connecting the extended microphone with the radio communication equipment; an extended line connected between the microphone body and the adapter; a lighting module disposed on the microphone body; a power source set connected with the light module; and a light button disposed on the microphone body and connected with the lighting module for controlling the lighting module to radiate and provide a light source.

Certainly, the power source set can be a battery.

Certainly, the lighting module can be a high-power luminary.

Certainly, the lighting module can be an incandescent lamp.

Certainly, the lighting module can be a LED luminary.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates an extended microphone for a radio communication equipment according to the prior art;

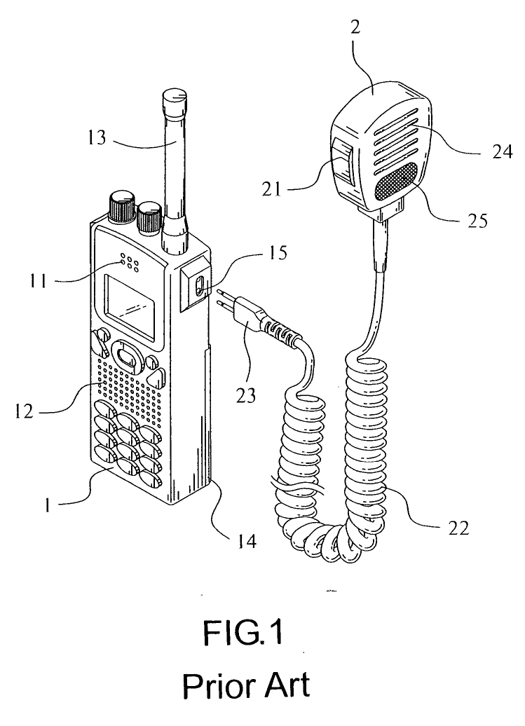

FIG. 2 illustrates a first embodiment of an extended microphone with a lighting module for a radio communication equipment according to the present invention;

FIG. 3 illustrates a second embodiment of an extended microphone with a lighting module for a radio communication equipment according to the present invention; and

FIG. 4 illustrates a third embodiment of an extended microphone with a lighting module for a radio communication equipment according to the present invention.

### DETAILED DESCRIPTION OF THE PREFERRED EMBODIMENT

The present invention discloses an extended microphone for a radio communication equipment, and the objects and advantages of the present invention will become more readily apparent to those ordinarily skilled in the art after reviewing the following detailed description. The present invention needs not be limited to the following embodiment.

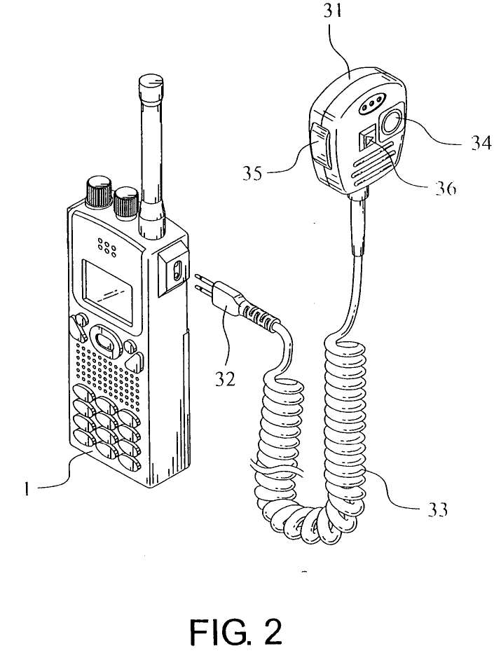

Please refer to FIG. 2. It illustrates a first embodiment of an extended microphone with a lighting module for a radio communication equipment according to the present invention. The extended microphone for a radio communication equipment, includes a microphone body 31; an adapter 32 for connecting the microphone body 31 with the radio communication equipment 1; an extended line 33 connected between the microphone body 31 and the adapter 32; and a lighting module 34 disposed on the microphone body 31 for providing a light source while the microphone body 31 is connected with the radio communication equipment 1 via the adapter 32.

In practice, the extended microphone further includes a voice-receiving button 35 connected to the microphone body 31 for enabling the microphone body 31 to receive a voice message, wherein the voice message is further transmitted into the radio communication equipment 1. The lighting module of the present invention can be enabled by means of inserting the adapter 32 into the radio communication equipment 1. Certainly, the extended microphone could further include a light button 36 disposed on the microphone body 31 and connected with the lighting module 34 for controlling the lighting module 34 to radiate. Meanwhile, the lighting module 34 can be a high-power luminary, i.e. a LED luminary.

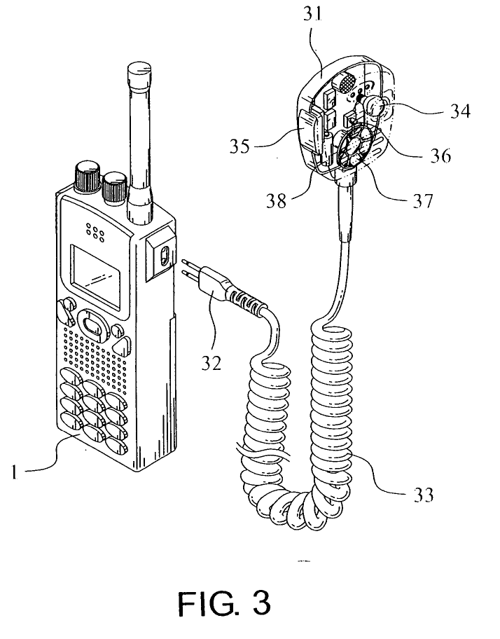

Please refer to FIG. 3. It illustrates a second embodiment of an extended microphone with a lighting module for a radio communication equipment according to the present invention. The extended microphone at least includes a microphone body 31; an adapter 32 for connecting the microphone body 31 with the radio communication equipment 1; and a lighting module 34 disposed on the microphone body 31 for providing a light source while the microphone body 31 is connected with the radio communication equipment 1 via the adapter 32. Similarly, the extended microphone further includes a voice-receiving button 35 connected to the microphone body 31 for enabling the microphone body 31 to receive a voice message, wherein the voice message is further transmitted into the radio communication equipment 1. On the other hand, the extended microphone further includes a loud speaker connected with the adapter 32 for receiving a received voice message and broadcasting the received voice message therefrom.

In practice, the extended microphone could further include a light button 36 disposed on the microphone body 31 and connected with the lighting module 34 for controlling the lighting module 34 to radiate. Therefore, the extended microphone can further include a power source set 38 connected with the lighting module 34 for providing the lighting module 34 with an individual power, wherein the power source set 38 is a battery.

Furthermore, the lighting module 34 can be an incandescent lamp; and the microphone body 31 and the adapter 32 can be connected via an extended line 33.

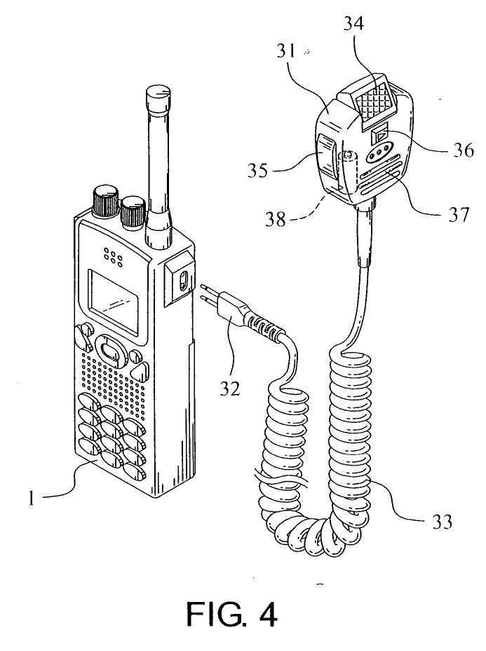

Please refer to FIG. 4. It illustrates a third embodiment of an extended microphone with a lighting module for a radio communication equipment according to the present invention. The extended microphone includes at least a microphone body 31; an adapter 32 for connecting the microphone body 31 with the radio communication equipment 1; an extended line 33 connected between the microphone body 31 and the adapter 32; a lighting module 34 disposed on the microphone body 31; a power source set 38 connected with the lighting module 34; and a light button 36 disposed on the microphone body 31 and connected with the lighting module 34 for controlling the lighting module 34 to radiate. Preferably, in this embodiment, the lighting module 34 can be controlled by means of rotating to electrify and enabled to radiate. Meanwhile the lighting module 34 can be a high-power luminary, i.e. a LED luminary or an incandescent lamp.

Accordingly, the present invention provides an extended microphone for a radio communication equipment by introducing a lighting module thereby providing a lighting function without refitting the relative radio communication equipment. Obviously, the present invention possesses many outstanding characteristics, effectively improves upon the drawbacks associated with the prior art in practice and application, produces practical and reliable products, bears novelty, and adds to economical utility value.

Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An extended microphone for a radio communication equipment, comprising:
a microphone body; an adapter for connecting said extended microphone with said radio communication equipment;
an extended line connected between said microphone body and said adapter; and a lighting module disposed on said microphone body for providing a light source while said extended microphone is connected with said radio communication equipment via said adapter.

2. The extended microphone according to claim 1 further comprising a voice-receiving button connected to said microphone body for enabling said microphone body to receive a voice message, wherein said voice message is further transmitted into said radio communication equipment.

3. The extended microphone according to claim 1 further comprising a light button disposed on said microphone body and connected with said lighting module for controlling said lighting module to radiate.

4. The extended microphone according to claim 1 further comprising a power source set connected with said lighting module for providing said lighting module with an individual power.

5. The extended microphone according to claim 1, wherein said lighting module is one selected from a group of a high-power luminary, an incandescent lamp, and a LED luminary.

6. An extended microphone for a radio communication equipment, at least comprising:
a microphone body; an adapter connected with said microphone body for linking said extended microphone and said radio communication equipment;
and a lighting module disposed on said microphone body for providing a light source while said extended microphone and said radio communication equipment are linked via said adapter.

7. The extended microphone according to claim 6 further comprising a voice-receiving button connected to said microphone body for enabling said microphone body to receive a voice message, wherein said voice message is further transmitted into said radio communication equipment.

8. The extended microphone according to claim 6 further comprising a light button disposed on said microphone body and connected with said lighting module for controlling said lighting module to radiate.

9. The extended microphone according to claim 6 further comprising a power source set connected with said lighting module for providing said lighting module with an individual power.

10. The extended microphone according to claim 6, wherein said lighting module is a high-power luminary.

11. The extended microphone according to claim 6, wherein said lighting module is an incandescent lamp.

12. The extended microphone according to claim 6, wherein said lighting module is a LED luminary.

13. The extended microphone according to claim 6 further comprising an extended line connected between said microphone body and said adapter.

14. An extended microphone for a radio communication equipment, comprising:
a microphone body; an adapter for connecting said extended microphone with said radio communication equipment;
an extended line connected between said microphone body and said adapter; a lighting module disposed on said microphone body;
a power source set connected with said light module; and
a light button disposed on said microphone body and connected with said lighting module for controlling said lighting module to radiate and provide a light source.

15. The extended microphone according to claim 14, wherein said power source set is a battery.

16. The extended microphone according to claim 14, wherein said lighting module is a high-power luminary.

17. The extended microphone according to claim 14, wherein said lighting module is an incandescent lamp.

18. The extended microphone according to claim 14, wherein said lighting module is a LED luminary.
